(19) United States
(12) Patent Application Publication
(10) Pub. No.: US 2012/0005619 A1
(43) Pub. Date: Jan. 5, 2012

(54) Method and Apparatus for Processing User Input

(75) Inventor: Seung Sub Jung, London (GB)

(73) Assignee: NOKIA CORPORATION, Espoo (FI)

(21) Appl. No.: 13/142,802

(22) PCT Filed: Dec. 28, 2009
(86) PCT No.: PCT/FI2009/051038

§ 371 Date: Sep. 22, 2011

(30) Foreign Application Priority Data
Dec. 31, 2008 (GB) 0823706.7

(51) Int. Cl. G06F 3/048

(52) U.S. Cl. 715/780

(57) ABSTRACT

User input to a computing device comprises a demarcated portion and a remainder portion. The demarcated portion comprises a label or data type which is associated with an application. On processing the user input, the associated application is instructed to open a data object and use the data of the demarcated portion and the remainder portion for the data object. Rules specify which applications may be associated with which data types and labels.

### FIELD OF EXAMPLE EMBODIMENTS

Example embodiments of the invention relate to a method and apparatus for processing user input.

### BACKGROUND

User input for computing devices may comprise instructions for the computing device to execute a desired function or data. In certain instances the distinction between instructions for the device and data depends on the context of the user input. The same user input may, in certain circumstances comprise an instruction for the device and, in other circumstances, comprise data to be used by the device in, for example, an application operating on the device.

### SUMMARY

Example embodiments of the invention extend to a method comprising:
receiving a user input comprising an application data portion;
recognising at least a part of said application data portion as data associated with an application;
instructing said associated application to open a data object in response to recognising at least a part of said application data portion as data associated with said application; and
passing information corresponding to said part of said application data portion recognised as data associated with said application to said associated application for use with said data object.

The user input may be demarcated into said application data portion and a remainder portion, in which case the method further comprises passing data relating to said remainder data portion to said associated application.

The application data portion may include data of a predetermined type, and wherein said recognising at least a part of said application data portion as data associated with an application may comprise recognising said data type.

Recognising said data type may further comprise prompting a user to confirm said data type.

Recognising at least a part of said application data portion as data associated with an application may comprise associating said type with said application.

The application data portion may further comprise a label and wherein said recognising at least a part of said application data portion as data associated with an application may further comprise associating said label with said application.

The application data portion may further comprise a data portion comprising instructions for use with an associated application.

The associations of a label or a data type with an application may be contained in a set of rules and the method may further comprise having a user specify one or more of said rules.

The user input may only comprises data for use with a single application.

Part of said application data portion may comprise data associated with more than one application, and in this case, the method may further comprise prompting a user to select one of said associated applications and instructing said selected application to open a data object.

The method may further comprise receiving said user input from a user interface, said user interface being configured so that any input from a user may be demarcated as said application data portion.

The user input may have been demarcated by said user.

Further example embodiments of the invention extend to an apparatus, comprising:
at least one processor; and
at least one memory including computer program code
the at least one memory and the computer program code configured to, with the at least one processor, cause the apparatus to perform at least the following:
   receiving a user input comprising an application data portion;
   recognising at least a part of said application data portion as data associated with an application;
   instructing said associated application to open a data object in response to recognising at least a part of said application data portion as data associated with said application; and
   passing information corresponding to said part of said application data portion recognised as data associated with said application to said associated application for use with said data object.

The user input may be demarcated into said application data portion and a remainder portion, in which case the apparatus may further perform: passing data relating to said remainder data portion to said associated application.

The application data portion may include data of a predetermined type, and in this case, said recognising at least a part of said application data portion as data associated with an application may comprise recognising said data type.

Recognising said data type may further comprise prompting a user to confirm said data type.

Recognising at least a part of said application data portion as data associated with an application may comprise associating said type with said application.

The application data portion may further comprise a label and, in this case, said recognising at least a part of said application data portion as data associated with an application may further comprise associating said label with said application.

The application data portion may further comprise a data portion comprising instructions for use with an associated application.

The associations between a label or a data type and an application may be contained in a set of rules, and a user may specify one or more of said rules.

The user input may only comprises data for use with a single application.

Part of said application data portion may comprise data associated with more than one application and, in this case, said apparatus may further perform: prompting a user to select one of said associated applications and instructing said selected application to open a data object.

The apparatus may further perform: receiving said user input from a user interface, said user interface being configured so that any input from a user may be demarcated as said application data portion.

The user input may have been demarcated by said user.

Further example embodiments of the invention extend to a computer program product comprising a computer-readable medium bearing computer program code embodied therein for use with a computer, the computer program code comprising:
code for receiving a user input comprising an application data portion;
code for recognising at least a part of said application data portion as data associated with an application;
code for instructing said associated application to open a data object in response to recognising at least a part of said application data portion as data associated with said application; and
code for passing information corresponding to said part of said application data portion recognised as data associated with said application to said associated application for use with said data object.

The computer program product may further comprising computer program code for performing the methods as herein described.

Further example embodiments of the invention extend to a computer program, comprising:
code for receiving a user input comprising an application data portion;
code for recognising at least a part of said application data portion as data associated with an application;
code for instructing said associated application to open a data object in response to recognising at least a part of said application data portion as data associated with said application; and
code for passing information corresponding to said part of said application data portion recognised as data associated with said application to said associated application for use with said data object
when the computer program is run on a processor.

The computer program may further comprise code for performing the methods as herein described.

The computer program may be a computer program product comprising a computer-readable medium bearing computer program code embodied therein for use with a computer.

Further example embodiments of the invention extend to a method comprising:

specifying an input comprising a demarcated portion;

determining a label or data type of data of said demarcated portion;

instructing an application associated with said label or said data type to open a data object in response to determining said label or data type of data of said demarcated portion;

passing data from said demarcated portion to said associated application; and

using said data passed to said application for the opening of said data object.

### BRIEF DESCRIPTION OF THE DRAWINGS

Example embodiments of the invention are hereinafter described with reference to the accompanying diagrams where:

FIG. 1 is a schematic diagram of a mobile computing device representing an example of a device in which embodiments of the invention may be implemented;

FIG. 2 is a schematic diagram of hardware components of the mobile computing device of FIG. 1;

FIG. 3 is a block diagram representing aspects of the mobile computing device of FIG. 1;

FIG. 4 is a schematic diagram of subcomponents of the mobile computing device of FIG. 1;

FIG. 5 is a display of a device illustrating user input;

FIG. 6 is a process diagram of an example embodiment of the invention;

FIG. 7 is a process diagram of an example embodiment of the invention;

FIG. 8 is a display of a device illustrating user input; and

FIG. 9 is a process diagram of an example embodiment of the invention;

### DESCRIPTION OF EXAMPLE EMBODIMENTS

A description of a number of embodiments of the invention follows, provided by way of example only.

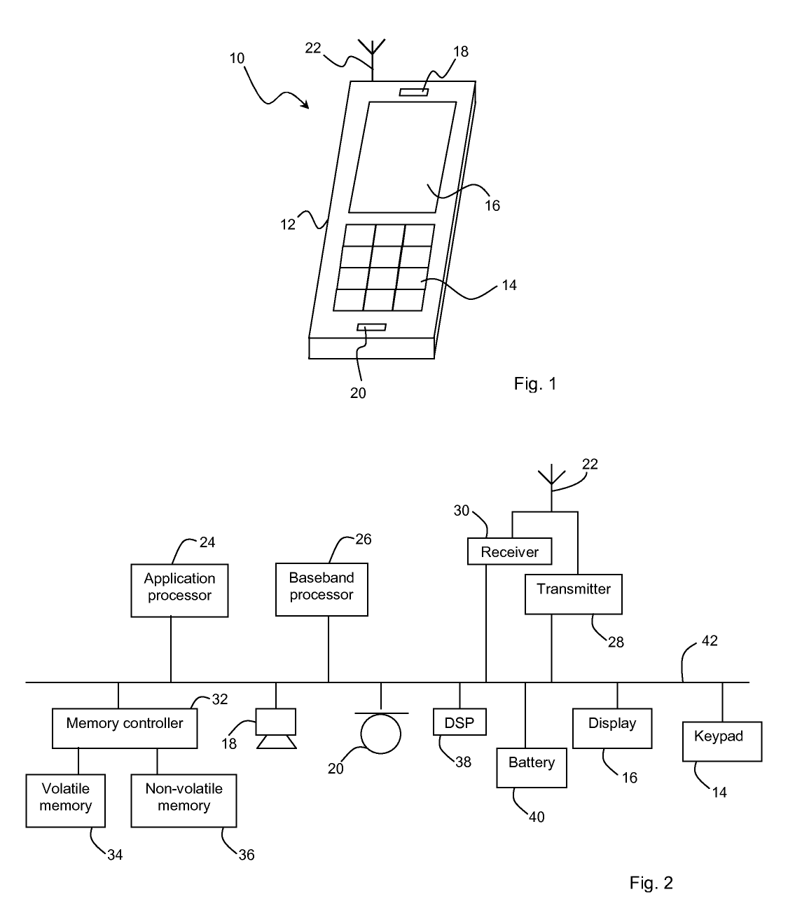

FIG. 1 is a schematic diagram of a mobile computing device 10 having a casing 12. The computing device 10 here implements the embodiments to be described. The casing 12 of the device 10 encapsulates a keypad 14, a display 16, a speaker 18 and a microphone 20. The device 10 further includes an antenna 22. The device 10 illustrated in FIG. 1 is a mobile device in that it may be held in a user's hand. It may be used to participate in communication sessions, in particular, telephone calls. During such sessions the device 10 may be utilised so that the speaker 18 is held to a user's ear and the microphone 20 is situated in proximity to a user's mouth. Although example embodiments relate to a mobile computing device, it is to be realised that the invention is not limited in this respect. Further embodiments of the invention may be implemented on computing devices which are not mobile or those which do not necessarily function primarily as communication devices.

FIG. 2 is a schematic illustration showing the arrangement of certain of the hardware components of the device 10 of FIG. 1. The keypad 14, display 16, speaker 18 and microphone 20 of this embodiment are connected to a system bus 42. The bus 42 is further connected to an application processor 24, a baseband processor 26, a digital signal processor (DSP) 38, a transmitter 28, a receiver 30 and a battery 40, in this embodiment. Transmitter 28 and receiver 30 of this embodiment are connected to antenna 22. The bus 42 is further connected to a memory controller 32 which is, in this embodiment, connected to a volatile memory 34 and a non-volatile memory 36. The application processor 24 of this embodiment processes instructions related to various software modules and operating system software which run on the device 10 and which provide various functionality of the device 10. The baseband processor 26 of this embodiment is concerned with the communication functions and to this end controls a telephony stack and communicates with the transmitter 28 and receiver 30 to establish communications by means of the antenna 22. The various processing elements of the device 10 such as the application processor 24 and baseband processor 26 may, in an alternate embodiment, be provided on a single processor or on more than two processors.

Memory controller 32 of this embodiment controls the access to, and interaction with, volatile memory 34 and non-volatile memory 36. The application processor 24 of this embodiment is able to communicate with the various hardware elements as well as the memory controller 32 and thereby control the operation of the various hardware elements according to software instructions stored on volatile memory 34 or non-volatile memory 36.

Only a single bus, bus 42, is illustrated in FIG. 2. It is to be realised that this bus may be replaced by two or more buses in alternative embodiments and that the topology of FIG. 2 would vary accordingly. Furthermore, known computing devices include hardware components additional to those illustrated in FIG. 2 which may be incorporated into embodiments of the invention, but these are well known in the art and are not further described or illustrated herein.

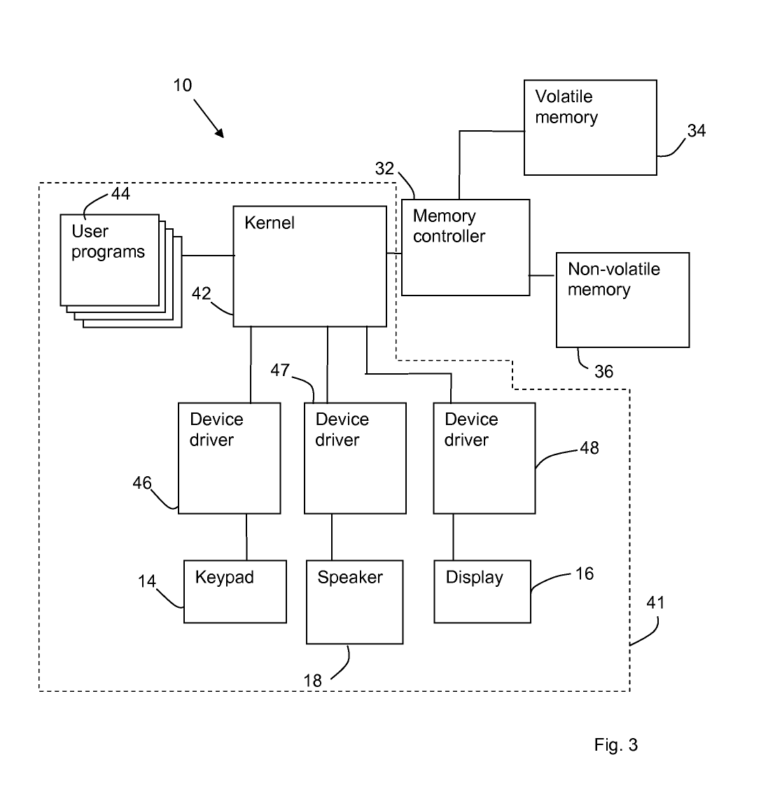

FIG. 3 is a diagram illustrating various hardware and software components of the device 10. The software operating on the device 10 of this embodiment can be categorised in various ways. Certain software of this embodiment operates to manage the resources provided by the various hardware components and to establish an operational environment in which other software executes. This software is represented in FIG. 3 by a kernel 42. The kernel interacts with the memory controller 32 which, as previously described, is connected to volatile memory 34 and non-volatile memory 36 of this embodiment. The kernel 42 is further connected to a plurality of user programs 44 each of which may access the hardware components in a manner dictated by the kernel 42 of this embodiment. The kernel 42 is further connected to the keypad 14 by means of device driver 46, to speaker 18 by means of device driver 47 and to the display 16 by means of device driver 48 in this embodiment. Only certain of the hardware components have been illustrated but, generally, the kernel 42 of this embodiment controls the hardware resources of the device 10 through various device drivers. Furthermore, although the device drivers have been illustrated as separate to the kernel 42, it is possible for some or all of them to be incorporated into the kernel 42 in alternative embodiments.

The software components of FIG. 3 are delineated by dashed area 41 in this embodiment. However, this distinction between software and hardware is not essential. Components depicted as software in FIG. 3 may be rendered in hardware, and those depicted as hardware may, in certain circumstances, be rendered as software in further embodiments. Furthermore, some components may have a software portion as well as a hardware portion in further embodiments.

During operation of the device, software instructions stored in non-volatile memory 36 of this embodiment establish the kernel 42, the user programs 44 and the device drivers 46, 47 and 48. Through the use of the various components illustrated in FIG. 3 a user is able to utilise the device 10 of this embodiment according to the functionality provided by the various user programs 44. For example, a user uses the keypad 14 of this embodiment to communicate with the kernel 42 by means of device driver 46 to cause one of the user programs 44 to access data stored on non-volatile memory 36 by means of memory controller 32. The kernel 42 of this embodiment then causes the data supplied by memory controller 32, together with instructions supplied by the user program, to be sent to the application processor 24 (FIG. 2). The application processor 24 of this embodiment will return results from the data and instructions, generally utilising volatile memory 34 in the process, and these will be returned to the user program by the kernel 42. On further instructions from the user program, the kernel 42 will cause the results to be displayed to the user on display 16 by means of device driver 48.

Furthermore, the display 16 of this embodiment is a touch sensitive display which accepts user input. The display of this embodiment may be used by a user to input data and commands.

The illustration of FIG. 3 is presented merely by way of example. Devices on which example embodiments of this invention may operate comprise more or fewer components than those shown. Implementations of embodiments of the invention are not dependent on the precise arrangement and configuration of the components shown in FIGS. 1, 2 and 3. Therefore other components with similar functionality may be substituted and further components added thereto or illustrated components omitted therefrom without affecting the operation of example embodiments of the invention.

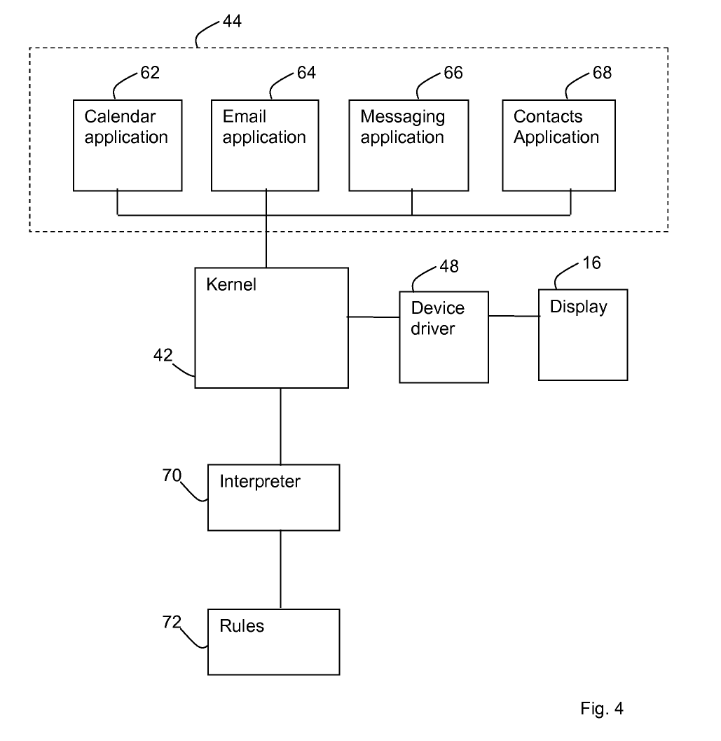

FIG. 4 illustrates the manner in which certain components of the mobile computing device 10 of this embodiment are interconnected. As mentioned above, the kernel 42 of this embodiment is connected to user programs 44. FIG. 4 illustrates four of the user programs 44 of this embodiment: calendar application 62, email application 64, messaging application 66 and contacts application 68. Example embodiments of the invention include many more user applications than those illustrated in FIG. 4. Furthermore, further example embodiments of the invention operate with applications not illustrated or discussed herein.

The kernel 42 of this embodiment is connected to device driver 48 which is connected to display 16. Furthermore, the kernel 42 of this embodiment is connected to an interpreter 70 which is connected to a set of rules 72. The interpreter 70 of this embodiment is also one of the user programs 44. The interpreter 70 of this embodiment interprets input received from the display 16 via device driver 48 and kernel 42 and performs certain actions with respect to this input as described below. Although FIG. 4 illustrates the interpreter 48 receiving input from display 16; in further embodiments, the interpreter may receive input deriving from a keypad, microphone or any other input device.

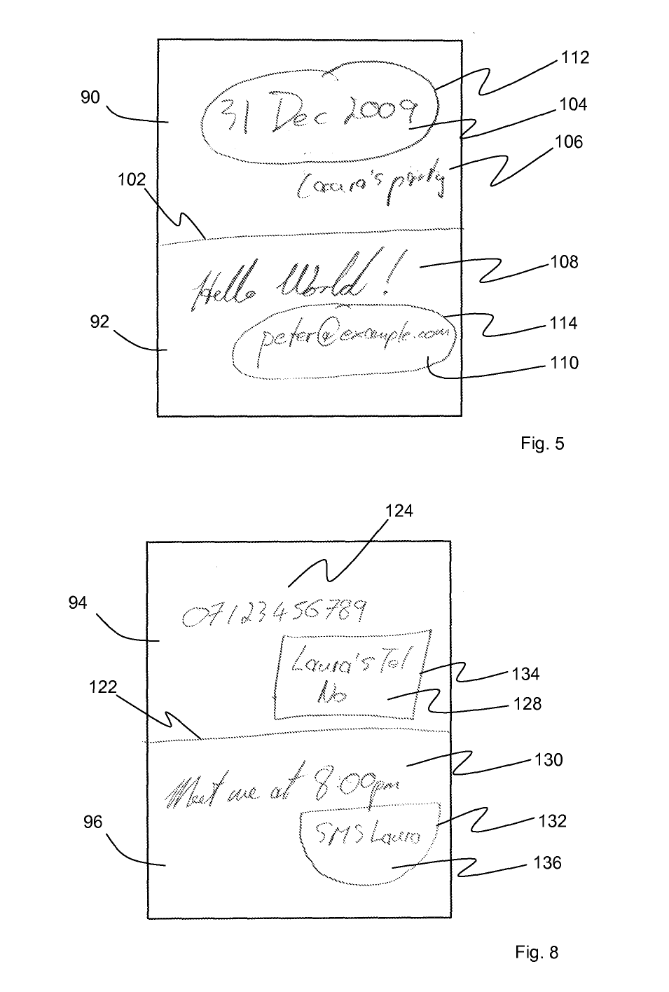

FIG. 5 illustrates the display 16 of the device 10 of this embodiment which has been used by a user to input information. In this example, the display 16 has been divided into two parts 90 and 92 by line 102 drawn by the user horizontally across the display 16. The interpreter 42 of this embodiment distinguishes the two portions of the display 16 as relating to two separate inputs. In further embodiments, both the input of part 90 and the input of part 92 are entered on display 16 which is cleared between the inputs. In such an embodiment, the interpreter does not need to distinguish between inputs.

The user input of part 90 comprises an application data portion 104 which in this example is the date “31 Dec. 2009” and a remainder data portion, “Laura's party”. In this example the user has noted that a party for Laura will be held on 31 Dec. 2009 and wishes to make a relevant entry in the calendar application 62 so that she will be reminded of the event closer to the appointed date. The date portion 104 in this example has been demarcated by the user by encircling this portion with line 112.

Similarly, the user input of part 92 has an application data portion which comprises an email address “peter@example.com” and a remainder data portion, “Hello World!”. In this example, the user wishes to email the address “peter@example.com” with the text “Hello World!” in the body of the email. The email address portion 110 in this example has been demarcated by the user by encircling this portion with line 114.

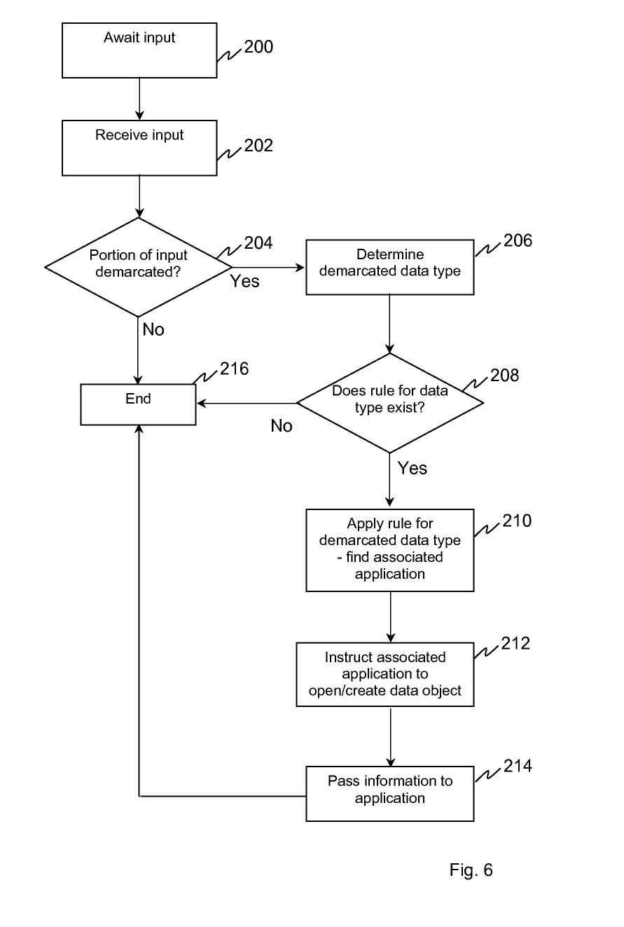

The operation of an example embodiment of the invention will be discussed with reference to FIG. 6. At block 200 of FIG. 6 the interpreter 70 of this embodiment awaits the user input. This block represents the start of the process and the interpreter of this embodiment will return to this block once the process described below finishes, or if it is aborted. At the following block 202, the interpreter 70 of this embodiment receives input from the display 16 via the device driver 48 and the kernel 42. In these embodiments, the interpreter includes handwriting recognition software whereby it is able to convert the handwritten input into a form which is recognisable by the device 10.

Furthermore, the interpreter 70 is able to recognise that a portion of the user input has been demarcated. In the examples of FIG. 5, demarcation has occurred when the user has encircled a portion of the input. In this embodiment, the interpreter recognises demarcation by the use of such encircling. In this embodiment the encircling may take the form of an oval, a square or any other shape formed using a single continuous line which crosses itself. Furthermore, the interpreter of this embodiment recognises an intended demarcation where the lines of the encircling do not quite touch.

In further embodiments, demarcation may take the form of one or more of highlighting, underlining, placement of arrows or other indicia, or any other user action which may be interpreted as distinguishing one portion of the input from another portion thereof.

At block 204 of the process of FIG. 6, the interpreter of this embodiment checks to ensure that a portion of the user input has been demarcated. If no such portion has been demarcated the process of this embodiment then terminates at block 216. If a portion has been demarcated, the process proceeds to block 206 where the data type of the demarcated portion is determined. Furthermore, at block 204 data verification occurs. Therefore, if the process is unable to determine the data type of the demarcated portion, the process will terminate. In a further embodiment, the user is prompted to confirm that the type identified, if any, is correct.

The identification of data types may include the use of regular expressions to identify user input such as dates, times, postal addresses, telephone numbers and email addresses as data conforming to those types. Other information such as names or addresses may be identified by comparing the data to a source such as a database.

The process then proceeds to block 208 where a determination is made whether a rule identifying an associated application exists for this data type. The form and content of the rules is discussed in greater detail below. If a rule for the determined data type does not exist, the process will terminate at block 216. If a rule for the determined data type does exist, the process will proceed to block 210. At block 210 the rule corresponding to the identified data is applied. In this embodiment, rules will identify an application associated with the data type previously recognised. Therefore, as a result of this, the application identified by the rule is launched, or brought to the foreground, at block 212. Alternatively the processing of some embodiments of the invention may occur without the application being launched and made visible to a user.

At the same time, or shortly thereafter, depending on the application and data concerned, information derived from the user input is passed to the identified application in block 214. This block 214 involves the interpreter 70 of this embodiment instructing the application determined by the specific rule to use information from the portion of the user input used to recognise the data type and find the associated application to create a new data object (as described below). The data object will, in many instances, be a data object associated with the application. In this embodiment, the data of the demarcated portion is sent in this manner to the associated application and used by the associated application to create a new data object. In a further embodiment, the interpreter 70 will interpret the information contained in the portion of the user input used to find the associated information and pass this interpreted information, in a set format, to the application. For example, if the user has entered a date as “11/12/09”, the interpreter will interpret this date as 11 Dec. 2009 and pass this date, in a standardised format to the application. In this embodiment, the interpreter comprises rules for interpreting the user input portion used to find the associated application so that it is able to convert this to a format which the application is able to use as input.

Furthermore at block 214 of this embodiment, the interpreter will also pass the remainder portion of the user input to the associated application together with the instructions to that application. The associated application in this embodiment will then use information from the user input in the manner dictated by the interpreter 70.

In the example of part 90 of FIG. 5, the demarcated portion of the user input comprises a demarcated date in the application data portion 104 demarcated by line 112. The remainder data portion comprises the text 106. Referring to FIG. 6, the operation of this embodiment will be considered with the data of the example of part 90 of FIG. 5.

At block 202 the interpreter 70 receives the input of all of part 90. At block 204, a determination is made by this embodiment whether a portion of the user input has been demarcated. In this instance, the user has demarcated the date, “31 Dec. 2009” 104 and therefore this embodiment will recognise the demarcation and treat this portion of the user input as the application data portion of the user input of this example. The rest of the user input, comprising the text 106, is treated as the remainder portion by the interpreter 70 of this embodiment.

The process of this embodiment applied to this example will then move to block 206 where the demarcated data type is determined. In this example, the demarcated data 104 is a date and the interpreter will recognise that data presented in a format comprising two digits followed by an abbreviation of a month name which, in turn, is followed by another two digits is a date. Once the application data type has been determined, the process of this embodiment will proceed to block 208 where a determination is made whether a rule for the data type exists. If a rule does exist, the process of this embodiment will apply that rule to the demarcated data type.

In the present example, Table 1 represents a portion of the rules (72 FIG. 4) used together with the data of the examples of FIG. 5.

TABLE 1

| Demarcated | | |
|---|---|---|
| Data Type | Application | Data Rules |
| Date | Calendar | Create new reminder at specified date with |
| | | remainder data as descriptor. |
| Email | Email | Create new email document with specified |
| Address | Application | email address in the ‘To’ field with |
| | | remainder data in body. |

As illustrated in table 1, the rules 72 of this embodiment comprise a rule relating to a date in the demarcated data type. As specified in Table 1, the rule states that where a date is recognised in the demarcated data type, the Calendar application 62 is called and the rule specifies that a new data object in the form of a reminder is created on the specified date. Therefore, for this example, the Calendar application will be launched at block 212 of the process of FIG. 6. Alternatively, if the Calendar application is already running (in a multitasking operating system environment) then it is brought to the foreground.

Then, at block 214, the information corresponding to the data of the recognised date, in this case the date 31 Dec. 2009, will be passed to the Calendar application together with the instruction to create a data object for this date. In this embodiment, the Calendar application 62 creates a new reminder on the specified date. Also at block 214 the remainder data of the user input; in this case, the text 106 “Laura's Party” will also be passed to the Calendar application together with the instruction to use this as a descriptor for the newly created event.

Although the manner in which the data of the demarcated portion and the remainder portion is passed to the application which has been associated with the data type depends on the rule specified in embodiments of the invention, in certain embodiments, the application (or demarcated portion) is used by the application to create a new data object and the remainder portion of the user input is used as content for that new document.

As a further example, the user input of the lower part 92 of the display 16 of FIG. 5 is considered. The user input of part 92 of FIG. 5 comprises an application data portion being demarcated email address: “peter@example.com” 110 demarcated by line 114 and remainder portion comprising the text “Hello World!” 108.

The process of the embodiment of FIG. 6 is applied to the user input of part 92. In this instance, at block 206 where the demarcated data is determined, the interpreter 70 recognises the email address 110 as an email address by the fact that it comprises a text string containing the “@” symbol followed by text which comprises a domain name.

When this embodiment, as applied to this example, reaches blocks 208 and 210 of FIG. 6, a reference to Table 1 will determine that a rule for the email data type exists. As specified in Table 1 the interpreter 70 will then cause the Email application 64 to launch (or be brought to the foreground) and to create a new data object being a new email document. The demarcated data is passed to the Email application (64 FIG. 4) in block 212 of the process of FIG. 6 with instructions to place that data in the “To” field of the new email document. Furthermore, the data of the remainder portion 110 is also passed to the Email application 64 with instructions to use that as the body of the new email document. (In an alternative embodiment, the data of the remainder portion is passed to the email application 64 as the subject line of the new email document.)

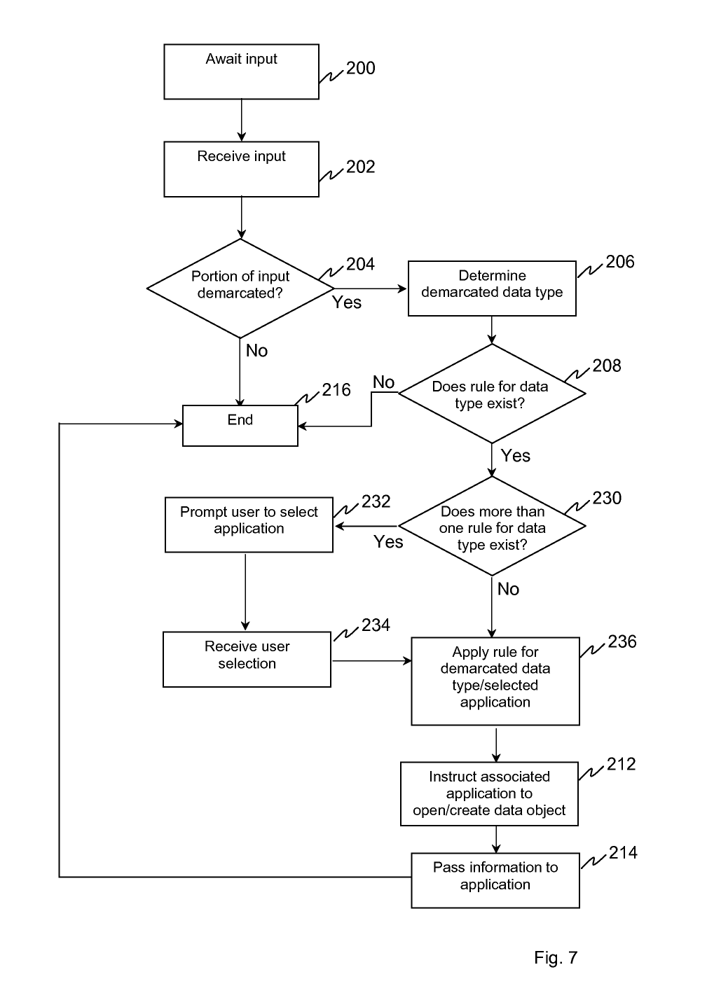

FIG. 7 illustrates a process according to a further embodiment. This embodiment is similar to the embodiment illustrated in FIG. 7 and where blocks of the two embodiments are the same, the same reference numerals have been used. Therefore, the process of the embodiment of FIG. 7 begins at block 200 where it awaits an input; receives the input at block 202; determines whether a portion of the input is demarcated at block 204; determines the demarcated data type at block 206 and then determines, at block 208 whether a rule for the determined data type exists at block 208. In these respects this embodiment is similar to that of FIG. 6.

The embodiment of FIG. 7 differs from that of FIG. 6 in that, if it determines at block 208 that a rule associated with the determined data type exists, the process will then proceed to block 230 where a determination is made whether more than one rule exists for the determined data type. According to this embodiment, more than one rule may be specified for a particular data type. For example, a date may be associated with the Calendar application 62 (FIG. 4) in the manner described above with reference to FIG. 6 and Table 1. In addition, the rules 72 of this embodiment may specify that a date is further associated with a reminder application which displays a reminder to the user on a specified date. In this example of the application of the embodiment of FIG. 7, the interpreter 70 will determine, at block 230, that more than a single rule exists for the date data type.

If the process of this embodiment does determine at block 230 that more than a single rule exists for the determined data type, the process will proceed to block 232. At block 232 the interpreter will prompt the user to determine which of the rules to apply to the determined data type. Thereafter, at block 234, the interpreter 70 receives the user's selection and, at block 236, applies the rule specified by the user at block 234 to the determined data type, thereby finding the associated application.

Where it is determined at block 230 that only a single rule exists for the determined data type, the process will proceed directly to block 236 where that rule is then applied to the determined data type.

Thereafter, the process of the embodiment of FIG. 7 follows the process of the embodiment of FIG. 6 in that the associated application is instructed to create a new data object at block 212 and the data from the demarcated portion and the remainder portion of the user input of this embodiment is passed to the application for use with the new data object.

FIG. 8 illustrates the display 16 of the device 10 of this embodiment which has been used by a user to input information. In this example, the display 16 has been divided into two parts 94 and 96 by line 122 drawn by the user horizontally across the display 16. The interpreter 42 of this embodiment distinguishes the two portions of the display 16 as relating to two separate inputs. In further embodiments, both the input of part 94 and the input of part 96 are entered on display 16 which is cleared between the inputs. In such an embodiment, the interpreter does not need to distinguish between inputs.

The user input of part 94 comprises a number 124 which in this example is “07123456789” and a portion 128, “Laura's Tel No”. In this example the user has noted that a person named Laura has a telephone number with that value and wishes to make a relevant entry in the contacts application 68 so that she will be able to recall the telephone number when required. The portion 128 in this example has been demarcated by the user by drawing a freehand square 134 about this portion. Therefore the portion 128 in this example is the application data portion and the number 124 is the remainder data portion.

The user input of part 96 comprises text 130: “Meet me at 8:00 pm” and a portion 136 comprising the text “SMS Laura”. In this example, the user wishes to send an SMS message to the phone of Laura (whose number is stored in the contacts application 68 with the body “Meet me at 8:00 pm”. The data portion 136 in this embodiment has been demarcated by the user by closed line 132. Therefore, in this example, the portion 136 comprises the application data portion and the text 130 the remainder data portion.

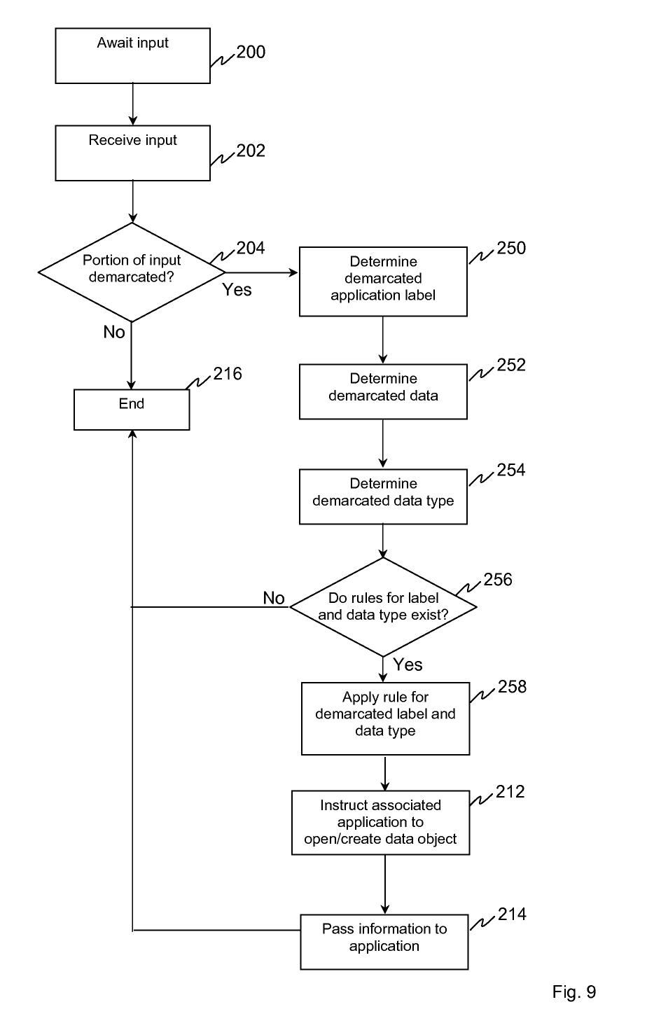

FIG. 9 illustrates an embodiment of the invention which may be used with the user input of part 96 of FIG. 8, with reference to which the operation of this embodiment will be described.

The process of the embodiment of FIG. 9 is similar to that of FIG. 6 in that the process begins at block 200 where input is awaited. The process then goes on to block 202 where the user input is received and block 204 where a determination is made as to whether a portion of the input has been demarcated by a user.

The embodiment of the process of FIG. 9 differs from that of FIG. 6 in that, if it is determined at block 204 that a portion of the user input has been demarcated, the process of this embodiment continues on to block 250 where a determination is made of a label of the demarcated data. This may involve recognising the data input (using handwriting recognition where appropriate) and comparing this data to a predetermined list of labels to determine if the label is one of those on the list (which may be stored externally to the computing device 10). In a further embodiment, the user may be prompted to confirm the outcome of the determination of block 250.

Once the determination of the label of the demarcated data has been made in block 250, the process continues on to block 252 where a determination is made of the demarcated label. The process of this embodiment will divide the demarcated portion into a label portion and a data portion. In this embodiment, the data portion is that portion of the demarcated input which does not include the label.

Block 252 of the process of the embodiment of FIG. 9 corresponds in certain respects to that of block 206 of the process of the embodiment of FIG. 6. At block 250, if there is no label to determine, the process will proceed on to block 254 and, in this instance, the embodiment of FIG. 9 would be similar to that of FIG. 6. The determination of the data type of block 254 of this embodiment will occur on the data portion of the demarcated input. The application data portion in this embodiment comprises a label and a data portion. The data portion of this embodiment contains instructions which, in the manner described, are passed to the associated application.

If the data portion of the demarcated input does not conform to a predetermined type, the process will retain the data portion and proceed to block 256.

At block 256 of the embodiment of FIG. 9, a determination is made whether a rule exists for the determined label and (optionally) for the determined data type. This is explained below with reference to the examples of FIG. 8.

If it is determined in this embodiment at block 256 that no rule exists for the determined label and data type, the process of this embodiment will terminate at block 216. However, if a rule for the determined label and data type exists, the process will continue on to block 258 where the rule determined to exist in block 256 is applied to the determined label and data type, thereby finding the associated application. Thereafter, the process of this embodiment proceeds to blocks 212 and 214 where the associated application is instructed to create a new data objection and the information corresponding to the data of the demarcated portion of the user input, and of the remainder portion, is utilised by the associated application in a manner suited to that application.

The operation of the embodiment of FIG. 9 will now be explained in operation with the example user inputs of FIG. 8.

The part 94 of the display 16 of FIG. 8 comprises a demarcated portion 128 demarcated by joined line 134. This demarcated portion 128 comprises the text “Laura's Tel No.” This, together with the remainder portion 124 comprising the text “07123456789” is received by the interpreter 70 of this embodiment at block 202. At block 250 the interpreter 70 of this embodiment reads the demarcated portion 128 and determines, by reference to the contacts database via the Contacts application 68, that an existing contact exists for a person named “Laura”. In this embodiment, the text “Laura” is determined to be the label. The interpreter then consults the rules 72 some of which, for this embodiment, are illustrated in Table 2.

TABLE 2

| Demarcated | | |
|---|---|---|
| Data Label | Application | Data Rules |
| Date | Calendar | Create new reminder at specified date with |
| | application | remainder data as descriptor. |
| Email | Email | Create new email document with specified |
| Address | application | email address in the ‘To’ field with |
| | | reminder data in body. |
| Contact | Contacts | Query contacts application to determine if |
| | application | name exists and add details if it does. |
| | | Tel. No. - update contact tel. no. |
| | | Email - update contact email address |
| “SMS” | Messaging | Query contacts application for no. of |
| | application | specified contact. Launch the messaging |
| | | application and start a new message to the |
| | | specified contact with remainder portion as |
| | | body. |

As illustrated in Table 2, once the interpreter 70 of this embodiment determines that a contact as specified exists, the contact details are updated by the interpreter 70 launching the Contacts application 68 and instructing it to update Laura's contact details with the telephone number specified in the remainder portion 124 of the user input (corresponding to blocks 210, 212 and 214 of FIG. 6). Also, as illustrated in Table 2, the interpreter relies on the rules 72 to determine which field in the contact details is to be updated.

In this embodiment, the interpreter 70 instructs the associated application to update an existing data object (in this instance the data object corresponding to Laura's contact details. In a further embodiment, the interpreter 70 may instruct the application to create a new data object (in this instance a new contact sheet for Laura) and insert the relevant information.

In a similar manner, the example of the user input specified in part 96 is considered. The demarcated portion 136 comprises the text “SMS Laura”. The interpreter 70 of this embodiment recognises the start string “SMS” as a specified label from Table 2 with a corresponding rule 72. According to this rule of this embodiment, the interpreter will instruct the Contacts application 68 to determine the mobile telephone number of the specified contact which, in this example, is “Laura”. If the Contacts application 68 cannot find a contact named “Laura” or cannot find a telephone number for an existing contact named “Laura”, the process of this embodiment will terminate at block 216.

Alternatively, if a contact with a mobile telephone exists, the interpreter 70 of this embodiment receives the mobile telephone number from the Contacts application 68 and, in the block 212, instructs the Messaging application 66 to create a new SMS message addressed to Laura's mobile telephone number with the data in the remainder portion 130: “Meet me at 8:00 pm” in the body of the message (in blocks corresponding to 212 and 214 of FIG. 9).

The application data portions of the user input of the Examples in FIG. 8 comprise a label (“Laura” for the example of part 94 and “SMS” for part 96). Furthermore, the application data portions of these examples also comprises a data portion: (“Tel No” for part 94 and “Laura” for part 96). The data portion is transmitted by the interpreter 70 to the associated application as instructions, as described.

Embodiments of the invention allow a user to enter information and use that information to create or update a data object by creating associations between a portion of the user input and one or more applications. In this manner, the user need not go through the actions of launching the desired application, opening a new or existing data object and using the information previously entered to update this data object.

Example embodiments of the invention are advantageously implemented on a computing device such as that illustrated in FIG. 1, or others, as a note taking application which allows the user to enter information while on a telephone call (for example) and, by demarcating a portion of the input, determine how that information is to be processed by the computing device. This helps to provide a quicker and simpler user experience.

Further example embodiments of the invention provide for user personalisation of the rules 72. In such embodiments the user is able to determine which applications are associated with the user data and how the data of the user input is to be used by the application in question.

Embodiments of the present invention may be implemented in software, hardware, application logic or a combination of software, hardware and application logic. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 1. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. A method comprising:
receiving a user input comprising an application data portion;
recognising at least a part of said application data portion as data associated with an application;
instructing said associated application to open a data object in response to recognising at least a part of said application data portion as data associated with said application; and
passing information corresponding to said part of said application data portion recognised as data associated with said application to said associated application for use with said data object.

2. The method according to claim 1 wherein said user input is demarcated into said application data portion and a remainder portion, further comprising passing data relating to said remainder data portion to said associated application.

3. The method according to claim 1 wherein said application data portion includes data of a predetermined type, and wherein said recognising at least a part of said application data portion as data associated with an application comprises recognising said data type.

4. The method according to claim 3 wherein recognising said data type further comprises prompting a user to confirm said data type.

5. The method according to claim 3 wherein said recognising at least a part of said application data portion as data associated with an application comprises associating said type with said application.

6. The method according to claim 5 wherein said application data portion further comprises a label and wherein said recognising at least a part of said application data portion as data associated with an application further comprises associating said label with said application.

7. The method according to claim 6 wherein said application data portion further comprises a data portion comprising instructions for use with an associated application.

8. The method according to claim 5 wherein said associations between a label or a data type and an application are contained in a set of rules, said method further comprising a user specifying one or more of said rules.

9. (canceled)

10. The method according to claim 1 wherein part of said application data portion comprises data associated with more than one application, said method further comprising prompting a user to select one of said associated applications and instructing said selected application to open a data object.

11. The method according to claim 1 further comprising receiving said user input from a user interface, said user interface being configured so that any input from a user may be demarcated as said application data portion.

12. The method according to claim 1 wherein said user input has been demarcated by said user.

13. An apparatus, comprising:
at least one processor; and
at least one memory including computer program code
the at least one memory and the computer program code configured to, with the at least one processor, cause the apparatus to perform at least the following:
receive a user input comprising an application data portion;
recognise at least a part of said application data portion as data associated with an application;
instruct said associated application to open a data object in response to recognising at least a part of said application data portion as data associated with said application; and
pass information corresponding to said part of said application data portion recognised as data associated with said application to said associated application for use with said data object.

14. The apparatus according to claim 13 wherein said user input is demarcated into said application data portion and a remainder portion, and wherein the at least one memory and the computer program code are configured to, with the at least one processor, cause the apparatus to perform at least the following: pass data relating to said remainder data portion to said associated application.

15. The apparatus according to claim 13 wherein said application data portion includes data of a predetermined type, and wherein recognise at least a part of said application data portion as data associated with an application comprises recognise said data type.

16. (canceled)

17. The apparatus according to claim 15 wherein said recognise at least a part of said application data portion as data associated with an application comprises associating said type with said application.

18. The apparatus according to claim 15 wherein said application data portion further comprises a label and said recognise at least a part of said application data portion as data associated with an application further comprises associate said label with said application, and wherein said application data portion further comprises a data portion comprising instructions for use with an associate application.

19-21. (canceled)

22. The apparatus according to claim 13 wherein part of said application data portion comprises data associated with more than one application, and wherein the at least one memory and the computer program code are configured to, with the at least one processor, cause the apparatus to perform at least the following: prompt a user to select one of said associated applications and instruct said selected application to open a data object.

23. The apparatus according to claim 13 wherein the at least one memory and the computer program code are configured to, with the at least one processor, cause the apparatus to perform at least the following: receive said user input from a user interface, said user interface being configured so that any input from a user may be demarcated as said application data portion.

24. The apparatus according to claim 13 wherein said user input has been demarcated by said user.

25. A computer program product comprising a computer-readable medium bearing computer program code embodied therein for use with a computer, the computer program code comprising:
code for receiving a user input, said user input comprising an application data portion;
code for recognising at least a part of said application data portion as data associated with an application;
code for instructing said associated application to open a data object in response to recognising at least a part of said application data portion as data associated with said application; and
code for passing information corresponding to said part of said application data portion recognised as data associated with said application to said associated application for use with said data object.

26-30. (canceled)
